(19) United States
(12) Patent Application Publication
(10) Pub. No.: US 2015/0314628 A1
(43) Pub. Date: Nov. 5, 2015

(54) PAGE LOCKING DEVICE AND METHODS OF MAKING AND USING THE SAME

(71) Applicant: David A. Neeley, JR., Canton, GA (US)

(72) Inventor: David A. Neeley, JR., Canton, GA (US)

(21) Appl. No.: 14/704,058

(22) Filed: May 5, 2015

Related U.S. Application Data
(60) Provisional application No. 61/988,806, filed on May 5, 2014.

(51) Int. Cl. B42D 12/00

(52) U.S. Cl. CPC B42D 12/00

(57) ABSTRACT

Page locking systems are disclosed. Methods of making and using page locking systems are also disclosed.

### CROSS-REFERENCE TO RELATED APPLICATIONS

This patent application claims the benefit of priority to U.S. provisional patent application Ser. No. 61/988,806 entitled “PAGE LOCKING DEVICE AND METHODS OF MAKING AND USING THE SAME” filed on May 5, 2014, the subject matter of which is incorporated herein in its entirety.

### FIELD OF THE INVENTION

The present invention relates to page locking device and methods of making and using the same.

### BACKGROUND OF THE INVENTION

There is currently no method or sufficient device available today to prevent individuals from reading books or magazines in a store without purchasing them. Individuals routinely take advantage of this situation for which there is no adequate remedy. On any given day throughout stores worldwide, individuals can browse through magazines and books taking time to read the entire contents, and then leaving the establishment without purchasing the item. Publishers, vendors, nor the industry as a whole, have created an adequate method to prevent individuals from reading the entire contents of these books or magazines before purchasing them. This poses a problem as book sales in particular have been declining in the past few years and it is my belief this is due in part because there is currently no sufficient device to prevent individuals from reading a book or magazine without purchasing it.

There have been attempts in the past to remedy this situation by packaging or completely covering the entire book or magazine in a thin cellophane material. The problem with this method is the thin material can easily be torn away, allowing an individual access to the contents of a book or magazine.

There exists a need in the art of a sufficient device for locking selected content of a book or magazine so an individual will have to purchase the item to gain access to all the information.

### SUMMARY OF THE INVENTION

The present invention is directed to page locking device and methods of making and using page locking devices. The page locking device of the present invention provides an alternative method of preventing individuals from reading the contents of a book or magazine without purchasing it. The page locking device allows individuals to glimpse only certain parts of a book or magazine to arouse their interest, prompting them to purchase the item. The page locking device can allow an individual to read and have access to the front and/or back covers and perhaps the first few pages succeeding the front cover and/or preceding the back cover. These pages may contain copyright information, a list of chapters, an introduction, credits, a bibliography, advertisements and pertinent information to get the reader interested in the book or magazine.

The page locking device can also be designed to allow access to the first few chapters or perhaps selected chapters of a book or magazine. The goal of the page locking device is to conceal selected content of a book or magazine tempting an individual to purchase the item to gain access to all the content. Unlike other devices, the page locking device typically uses a hard or semi-hard material to conceal certain parts of a book or magazine and not the entire item. The page locking device can be used on books, magazines, journals, documents, or any other form of media that contain pages. The page locking device method is accomplished by typically using two pieces of hard or semi-hard material combining and sealing them together to encapsulate a selected group of pages. The page locking device may, if desired, be disposable.

In one exemplary embodiment of the present invention, the page locking device of the present invention comprises a page lock system for preventing uncontrolled reading of printed material, said system comprising: a first sheet of material having a first sheet major surface extending along a front surface of said first sheet, and a first sheet outer periphery surrounding said first sheet major surface; and a second sheet of material having a second sheet major surface extending along a rear surface of said second sheet, and a second sheet outer periphery surrounding said second sheet major surface; said first sheet of material being attachable to said second sheet of material along at least a portion of (i) said first sheet outer periphery and (ii) said second sheet outer periphery so as to form a sealed enclosure sized to house a piece of printed material and having an overall thickness extending from said front surface to said rear surface; wherein (1) at least one of said first sheet major surface and said second sheet major surface further comprises a slot extending therethrough along a length thereof, each slot being sized to enable (i) one or more covers or (ii) one or more covers and one or more pages of the piece of printed material to extend therethrough, or (2) at least one of said first sheet major surface and said second sheet major surface further comprises a barcode along an outer surface thereof, said barcode providing electronic data relating to the piece of printed material, or (3) both (1) and (2).

In another exemplary embodiment of the present invention, the page locking device of the present invention comprises a page lock system for preventing uncontrolled reading of printed material, said system comprising: a first sheet of material having a first sheet major surface extending along a front surface of said first sheet, and a first sheet outer periphery surrounding said first sheet major surface; and a second sheet of material having a second sheet major surface extending along a rear surface of said second sheet, and a second sheet outer periphery surrounding said second sheet major surface; said first sheet of material being attachable to said second sheet of material along at least a portion of (i) said first sheet outer periphery and (ii) said second sheet outer periphery so as to form a sealed enclosure sized to house a piece of printed material and having an overall thickness extending from said front surface to said rear surface; wherein at least one of said first sheet major surface and said second sheet major surface further comprises a slot extending therethrough along a length thereof, each slot being sized to enable (i) one or more covers or (ii) one or more covers and one or more pages of the piece of printed material to extend therethrough.

In yet another exemplary embodiment of the present invention, the page locking device of the present invention comprises a page lock system for preventing uncontrolled reading of printed material, said system comprising: a first sheet of material having a first sheet major surface extending along a front surface of said first sheet, and a first sheet outer periphery surrounding said first sheet major surface; and a second sheet of material having a second sheet major surface extending along a rear surface of said second sheet, and a second sheet outer periphery surrounding said second sheet major surface; said first sheet of material being attachable to said second sheet of material along at least a portion of (i) said first sheet outer periphery and (ii) said second sheet outer periphery so as to form a sealed enclosure sized to house a piece of printed material and having an overall thickness extending from said front surface to said rear surface; wherein at least one of said first sheet major surface and said second sheet major surface further comprises a barcode along an outer surface of (i) the first sheet major surface, (ii) the second sheet major surface, or (iii) both (i) and (ii), said barcode providing electronic data about a piece of printed material that is positionable (or positioned) within said sealed enclosure.

The present invention is further directed to methods of making the page locking system of the present invention. In one exemplary embodiment, the method of making the page locking system comprises: forming a first sheet of material having a first sheet major surface extending along a front surface of the first sheet, and a first sheet outer periphery surrounding the first sheet major surface; forming a second sheet of material having a second sheet major surface extending along a rear surface of the second sheet, and a second sheet outer periphery surrounding the second sheet major surface; wherein the first sheet of material is attachable to the second sheet of material along at least a portion of (i) the first sheet outer periphery and (ii) the second sheet outer periphery so as to form a sealed enclosure sized to house a piece of printed material and having an overall thickness extending from the front surface to the rear surface; wherein (1) at least one of the first sheet major surface and the second sheet major surface further comprises a slot extending therethrough along a length thereof, each slot being sized to enable (i) one or more covers or (ii) one or more covers and one or more pages of the piece of printed material to extend therethrough, or (2) at least one of the first sheet major surface and the second sheet major surface further comprises a barcode along an outer surface thereof, the barcode providing electronic data relating to the piece of printed material, or (3) both (1) and (2).

In another exemplary embodiment, the method of making the page locking system comprises: forming a first sheet of material having a first sheet major surface extending along a front surface of the first sheet, and a first sheet outer periphery surrounding the first sheet major surface; forming a second sheet of material having a second sheet major surface extending along a rear surface of the second sheet, and a second sheet outer periphery surrounding the second sheet major surface; wherein the first sheet of material is attachable to the second sheet of material along at least a portion of (i) the first sheet outer periphery and (ii) the second sheet outer periphery so as to form a sealed enclosure sized to house a piece of printed material and having an overall thickness extending from the front surface to the rear surface; and wherein said method further comprises at least one of: (1) forming a slot extending through (i) the first sheet major surface, (ii) the second sheet major surface, or (iii) both (i) and (ii), each slot being sized to enable (i) one or more covers or (ii) one or more covers and one or more pages of the piece of printed material to extend therethrough, and (2) providing a barcode along an outer surface of (i) the first sheet major surface, (ii) the second sheet major surface, or (iii) both (i) and (ii).

The present invention is even further directed to methods of using the page locking system of the present invention. In one exemplary embodiment, the method of using the page locking system comprises: positioning a first sheet of material having a first sheet major surface extending along a front surface of the first sheet, and a first sheet outer periphery surrounding the first sheet major surface over a first cover of a piece of printed material; positioning a second sheet of material having a second sheet major surface extending along a rear surface of the second sheet, and a second sheet outer periphery surrounding the second sheet major surface over a second cover of the piece of printed material, the second cover being opposite the first cover; and attaching the first sheet of material to the second sheet of material along at least a portion of (i) the first sheet outer periphery and (ii) the second sheet outer periphery so as to form a sealed enclosure housing the piece of printed material such that (1) (i) one or more covers or (ii) one or more covers and one or more pages of the piece of printed material extend through a slot extending through (i) first sheet major surface, (ii) said second sheet major surface, or (iii) both (i) and (ii), or (2) at least one of the first sheet major surface and the second sheet major surface further comprises a barcode along an outer surface thereof, the barcode providing electronic data relating to the piece of printed material, or (3) both (1) and (2).

These and other features and advantages of the present invention will become apparent after a review of the following detailed description of the disclosed embodiments and the appended claims.

### BRIEF DESCRIPTION OF THE FIGURES

FIG. 1: Provides a perspective view of an exemplary page locking device.

FIG. 2: Provides a perspective view of the front and back half of an exemplary page locking device.

FIG. 3: Provides a perspective view of a standard book.

FIG. 4: Provides a perspective view of a standard book with the back and front cover open slightly and the front and back half of an exemplary page locking device.

FIG. 5: Provides a perspective view of the front and back half of an exemplary page locking device being inserted onto the front and back covers of a standard book.

FIG. 6: Provides a perspective view of the front and back half joined and sealed together to form an exemplary page locking device, locking the internal pages of a standard book.

FIG. 7: Provides a perspective view of an exemplary page locking device with the front and back covers of a standard book half closed.

FIG. 8: Provides a perspective view of an exemplary page locking device with the front and back covers of a standard book fully closed.

FIG. 9: Provides a perspective view of an exemplary page locking device with the front and back covers and additional pages of a standard book half closed.

FIG. 10: Provides a side view of an exemplary page locking device with the front and back covers and additional pages of a standard book half closed.

FIG. 11: Provides a perspective view of an exemplary page locking device with a bar code (e.g., QR code) positioned along an outer surface of the exemplary page locking device.

### DETAILED DESCRIPTION OF THE INVENTION

The present invention is directed to page locking device and methods of making and using page locking device. In particular, the present invention is directed to page locking device as shown in the figures, as described in the embodiment shown and described herein, and as recited in the claims below.

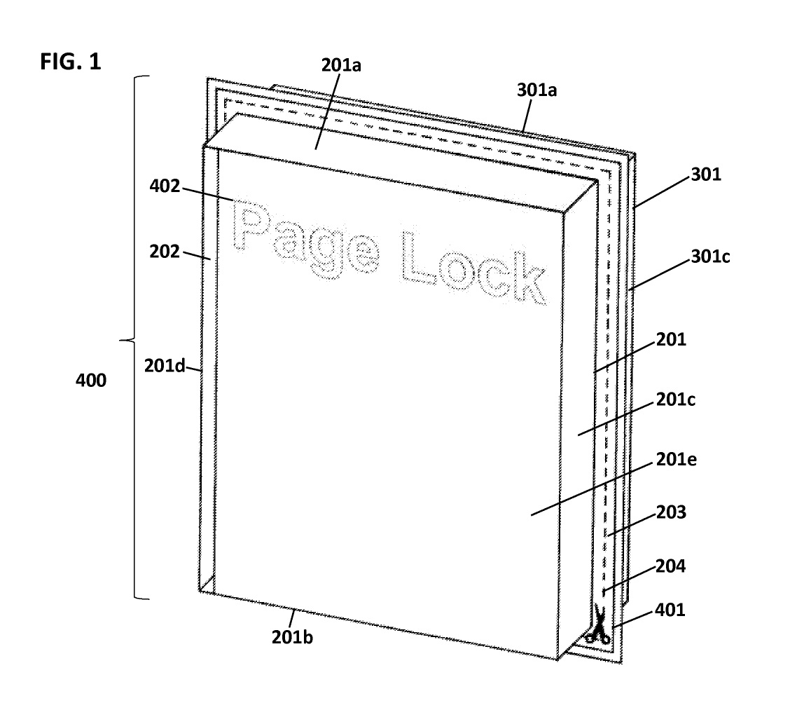

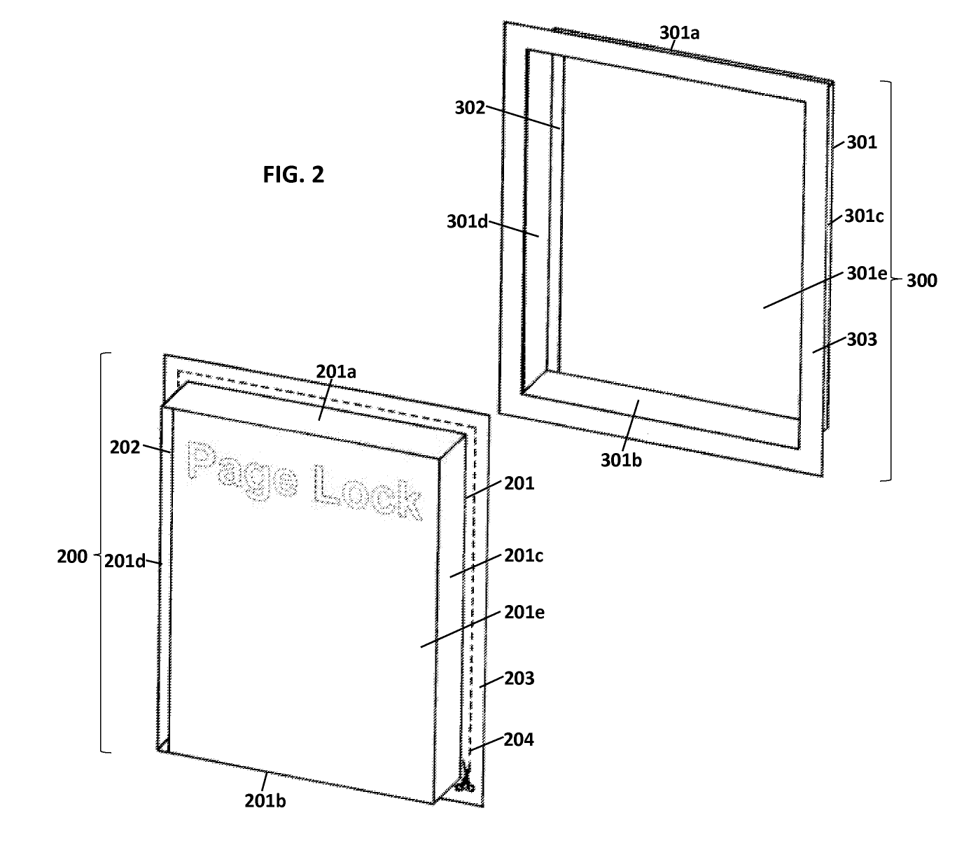

The page locking device 400 as shown in FIG. 1 may be formed using two identical halves: a front half 200 and a back half 300 as shown in FIG. 2; each may have the same identical measurements both internally and externally. Each half may contain a cavity to encapsulate selected pages, a slit or opening to allow the front and back cover and selected pages of a book or magazine to remain un-encapsulated, and a border to incorporate a cut line and seal. A logo or text 402 may be molded or imprinted anywhere on the page locking device 400 as shown in FIG. 1.

The front half 200 is comprised of three distinct features: a front half cavity 201; front half cavity slit 202; and a front half cavity border 203 as shown in FIG. 2.

Front half cavity 201 forms the main feature of front half 200. Front half cavity 201 has a top 201a; bottom 201b; front 201c; rear 201d; and side 201e as shown in FIG. 2. The top 201a, bottom 201b, front 201c, and rear 201d all extend outward from the front half cavity border 203 as shown in FIG. 2. The top 201a, bottom 201b, front 201c, and rear 201d are connected by a side 201e which together forms the front half cavity 201 as shown in FIG. 2. The geometry of front half cavity 201 may, if desired be substantially rectangular and elongated or any other suitable shape. The length, width, and depth of front half cavity 201 may be of any desired dimension to accommodate internal pages 103 of a book or magazine 100.

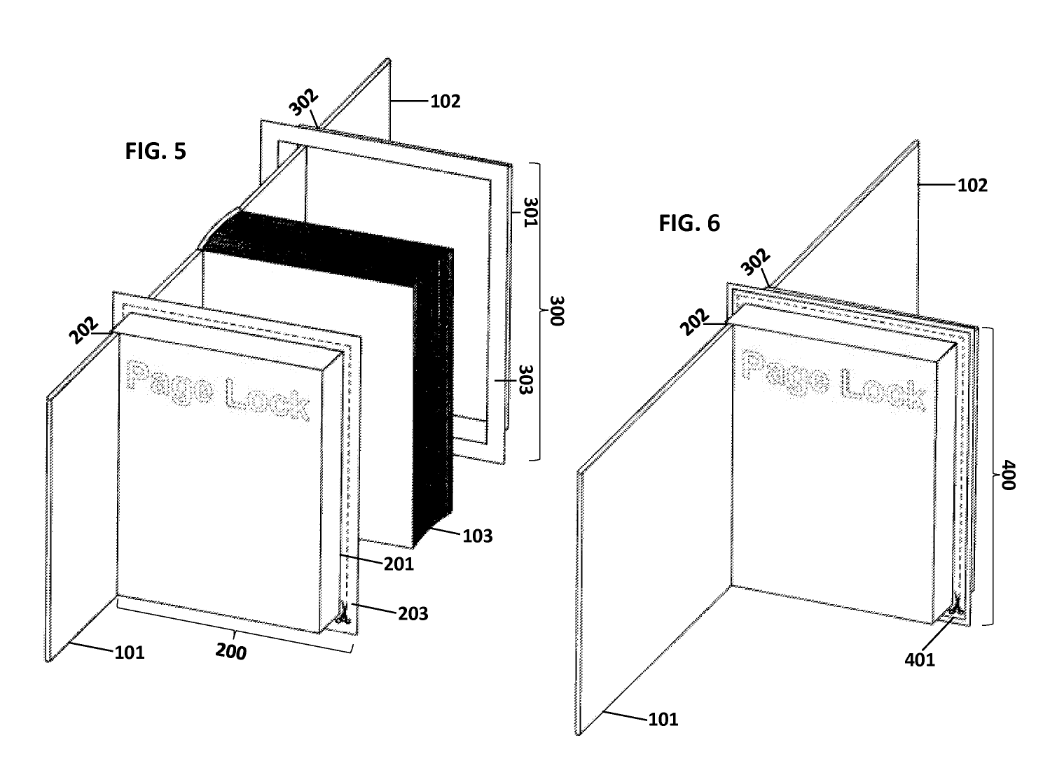

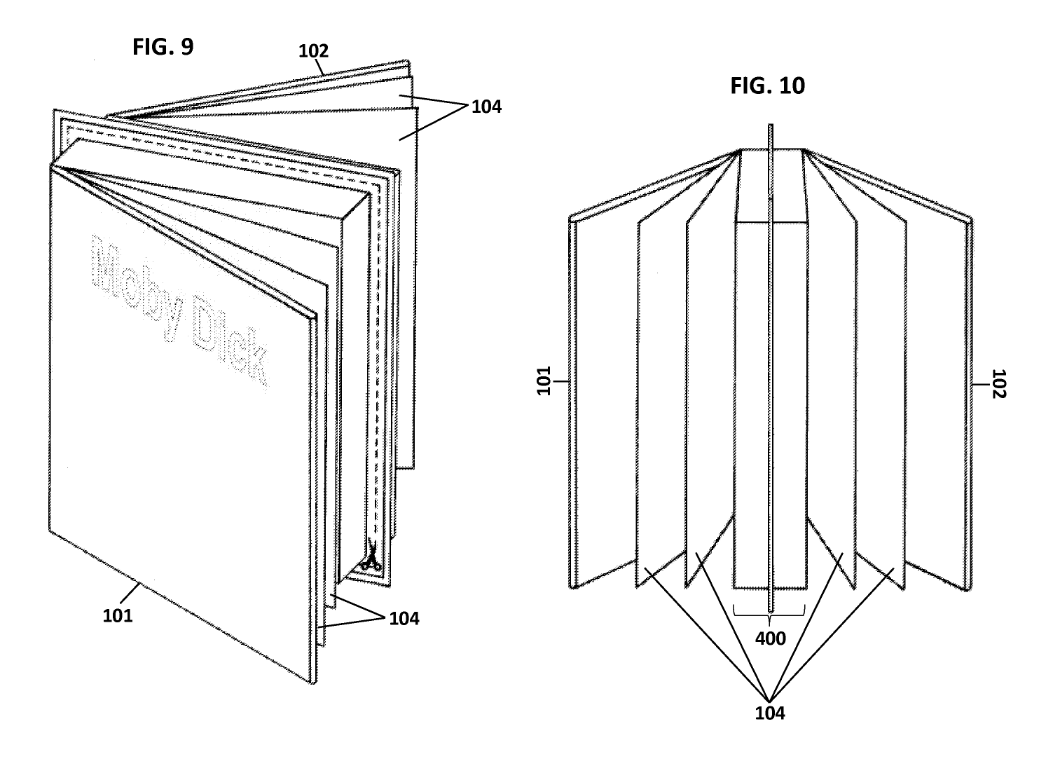

Front half cavity slit 202 is cut into the side 201 e and is located where the side 201 e and the rear 201d converge and runs vertically from the top 201a to the bottom 201b of the front half cavity 201 as shown in FIG. 2. Front half cavity slit 202 allows for a front cover 101 of a book or magazine 100 to pass thru as shown in FIG. 5-6. Front half cavity slit 202 also allows for additional pages 104 to pass thru as shown in FIG. 9-10. The geometry of front half cavity slit 202 may, if desired be substantially rectangular and elongated or any other suitable shape. The length and width of front half cavity slit 202 may be of any desired dimension to accommodate front cover 101 or additional pages 104 of a book or magazine.

Front half cavity border 203 surrounds front half cavity 201 on all four sides and is connected at the top 201a, bottom 201b, front 201c, and rear 201d. Front half cavity border 203 extends out from the front half cavity 201 and allows the front half 200 to be sealed together with the back half 300 forming the page locking device 400 as shown in FIG. 1. Front half cavity border 203 may if desired feature a cut line 204 as shown in FIG. 2. The cut line 204 encircles the front half cavity border 203 and serves as a guide to remove the front half 200 from back half 300 once they are joined together by a tamper proof seal 401 forming the page locking device 400. The cut line 204 serves only as a guide and is not essential in the construction and or use of the page locking device 400. A cut line 204 may be molded or imprinted onto front half cavity border 203. The geometry of front half cavity border 203 may, if desired be substantially rectangular and elongated or any other suitable shape. The length and width of front half cavity border 203 may be of any desired dimension to accommodate front half cavity 201.

The back half 300 is comprised of three distinct features: a back half cavity 301; back half cavity slit 302; and a back half cavity border 303 as shown in FIG. 2.

Back half cavity 301 forms the main feature of back half 300. Back half cavity 301 has a top 301a; bottom 301b; front 301c; rear 301d; and side 301e as shown in FIG. 2. The top 301a, bottom 301b, front 301c, and rear 301d all extend outward from the back half cavity border 303 as shown in FIG. 2. The top 301a, bottom 301b, front 301c, and rear 301d are connected by a side 301e which together forms the back half cavity 301 as shown in FIG. 2. The geometry of back half cavity 301 may, if desired be substantially rectangular and elongated or any other suitable shape. The length, width, and depth of back half cavity 301 may be of any desired dimension to accommodate internal pages 103 of a book or magazine 100.

Back half cavity slit 302 is cut into the side 301e and is located where the side 301e and the rear 301d converge and runs vertically from the top 301a to the bottom 301b of the back half cavity 301 as shown in FIG. 2. Back half cavity slit 302 allows for a back cover 102 of a book or magazine 100 to pass thru as shown in FIG. 5-6. Back half cavity slit 302 also allows for additional pages 104 to pass thru as shown in FIG. 9-10. The geometry of back half cavity slit 302 may, if desired be substantially rectangular and elongated or any other suitable shape. The length and width of back half cavity slit 302 may be of any desired dimension to accommodate back cover 102 or additional pages 104 of a book or magazine.

Back half cavity border 303 surrounds back half cavity 301 on all four sides and is connected at the top 301a, bottom 301b, front 301c, and rear 301d. Back half cavity border 303 extends out from the back half cavity 301 and allows the back half 300 to be sealed together with the front half 200 forming the page locking device 400 as shown in FIG. 1. The geometry of back half cavity border 303 may, if desired be substantially rectangular and elongated or any other suitable shape. The length and width of back half cavity border 303 may be of any desired dimension to accommodate back half cavity 301.

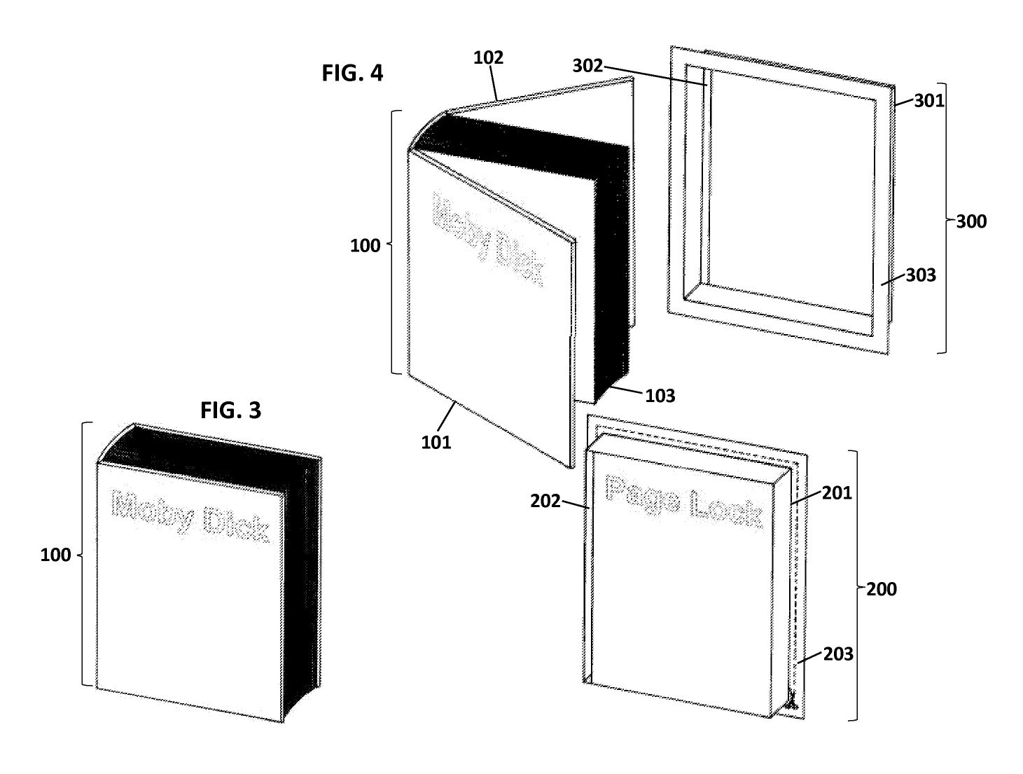

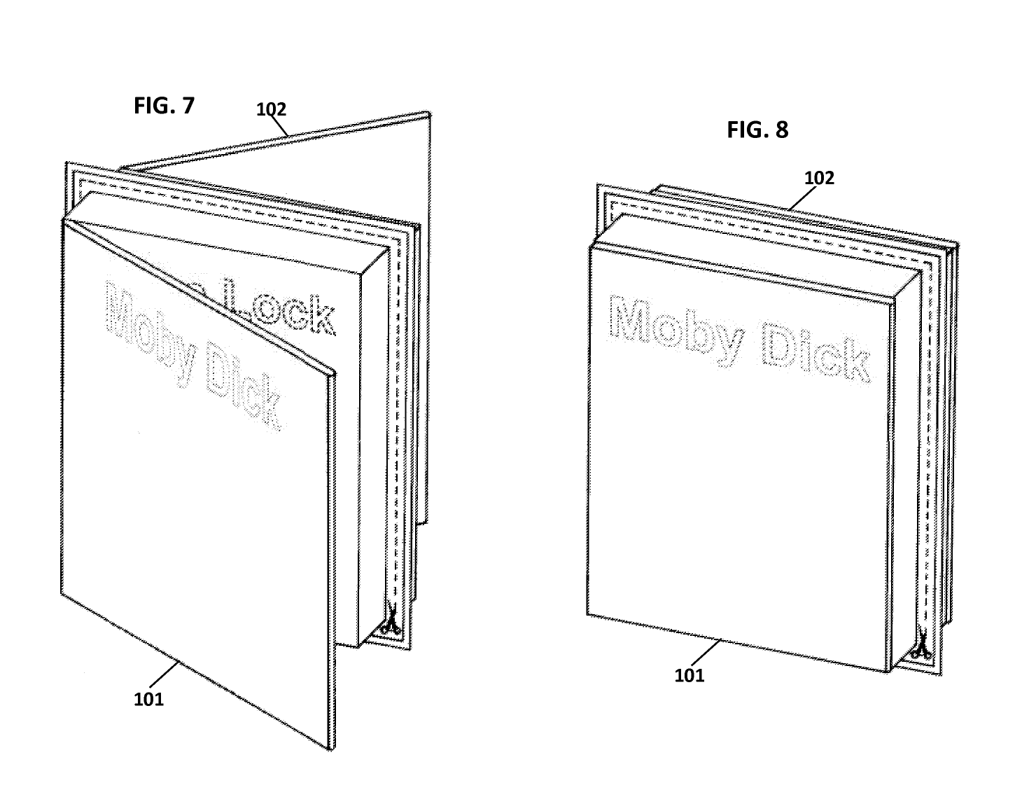

The process of encapsulating internal pages 103 between the front half 200 and the back half 300 to form the page locking device 400 is further described in FIG. 3-8. The process starts with a standard book or magazine 100 as shown in FIG. 3. The process continues by opening the front cover 101 and back cover 102 of a book or magazine 100 in preparation for the internal pages 103 to be encapsulated by the front half 200 and back half 300 as shown in FIG. 4. Once the front cover 101 and back cover 102 of a book or magazine 100 are completely opened to fully expose the internal pages 103, then the front half 200 and back half 300 are slid on. This is accomplished by inserting the front cover 101 thru the front half cavity slit 202 of front half 200 and back cover 102 thru the back half cavity slit 302 of back half 300 as shown in FIG. 5. The front half 200 and back half 300 contact each other and then sealed together forming a tamper proof seal 401 encapsulating the internal pages 103 as shown in FIG. 6. Additional embodiments of the page locking device 400 may feature the front half 200 and back half 300 hinged together on one side so a tamper proof seal 401 only has to applied on three sides instead of all four. The front cover 101 and back cover 102 can then be closed as shown in FIG. 7. The final result is a book or magazine 100 with the internal pages 103 locked by the page locking device 400 as shown in FIG. 8.

The page locking device 400 allows for additional pages 104 to remain un-locked or un-encapsulated as shown in FIG. 9-10. In this configuration, the final result is a book or magazine 100 with the internal pages 103 locked by the page locking device 400 while leaving the front cover 101, back cover 102, and additional pages 104 to remain un-locked or un-encapsulated as shown in FIG. 9-10.

The geometry of page locking device 400 may, if desired, be substantially rectangular and elongated or any other suitable shape. Page locking device 400 may, if desired, be cut, formed, or molded together into one solid, seamless, and uniform piece. Page locking device 400 may, if desired, be manufactured from any type of suitable material. The material may, if desired, be of homogenous composition, multi-composition of varying degrees, or laminated material. The material may be of any desired thickness. The material may, if desired, be rigid or have varying degrees of rigidity disposed along its lateral or longitudinal length. The material may be selected from plastic, rubber, polyethylene, polypropylene, or other material. Typically, page locking device 400 is formed from a polymeric material, such as polyvinyl chloride also known as PVC. The material may, if desired, be transparent or non-transparent. The material may, if desired, be translucent or non-translucent. The material may, if desired, come in any color. The length, width, or depth of page locking device 400 may be of any desired dimension to accommodate a book or magazine 100.

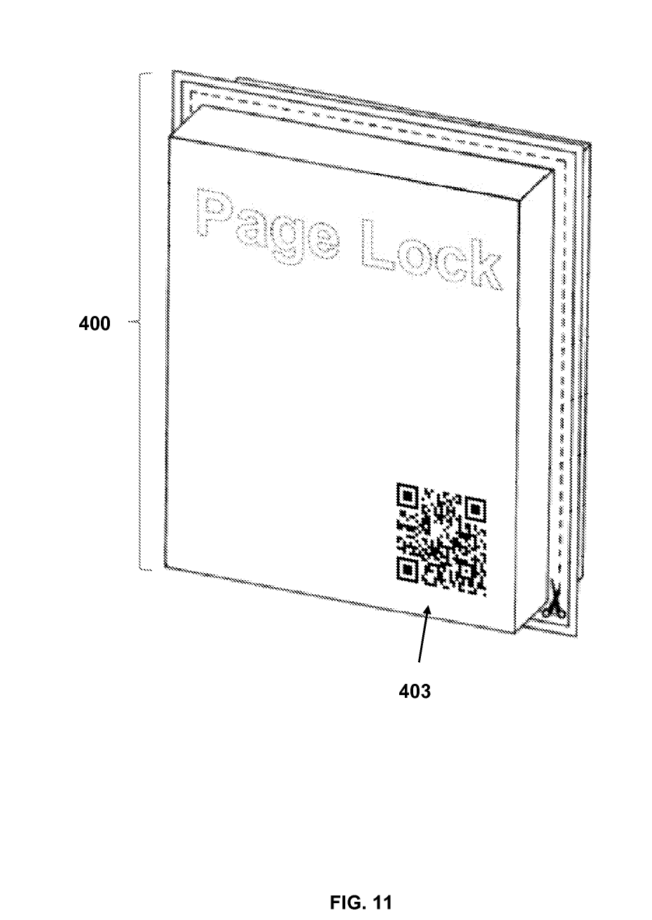

As shown in FIG. 11, page locking device 400 may further comprise a barcode 403 printed on page locking device 400. In the exemplary embodiment shown in FIG. 11, page locking device 400 does not comprise any slits 202/302. However, it should be noted that barcode 403 may be present on any page locking device 400 of the present invention.

In the exemplary embodiment shown in FIG. 11, barcode 403 allows an individual to scan the book or magazine via a scanner, cell phone, or other type of digital medium so as to obtain information relating to page locking device 400 with or without printed material therein. For example, barcode 403 may be used to direct the individual to a website, where information pertaining to a book or magazine (e.g., copyright information, a list of chapters, an introduction, credits, a bibliography, advertisements and pertinent information to get the reader interested in the book or magazine) is provided. The website may also allow access to the first few chapters or perhaps select chapters/pages of the book or magazine. If desired, the website would be able to conceal select content of the book or magazine tempting an individual to purchase the item to gain access to all of the content.

It is important to note that the term “barcode,” as used herein, refers to any pattern of lines, dots or shapes that represent data by varying the widths, sizes and spacing of these lines and/or shapes and may be referred to as one dimensional or multi dimensional and these patterns can then be recognized to correspond with actual data as is common knowledge. Barcodes include, but are not limited to, any pattern of lines, dots or shapes, QR codes (i.e., quick response codes), and data matrix type codes.

Any of the above-described components may be formed using conventional techniques. For example, many, if not all, of the above-described components may be thermoformed (e.g., molded) from the above-mentioned materials, and subsequently joined to and/or assembled with one another so as to result in the above-described page locking device of the present invention.

Key for Figures:

100=Book or Magazine

101=Front Cover

102=Back Cover

103=Internal Pages

104=Additional Pages

200=Front Half

201=Front Half Cavity

201a=top

201b=bottom

201c=front

201d=rear

201e=side

202=Front Half Cavity Slit

203=Front Half Cavity Border

204=Cut Line

300=Back Half

301=Back Half Cavity

301a=top

301b=bottom

301c=front

301d=rear

301e=side

302=Back Half Cavity Slit

303=Back Half Cavity Border

400=Page Locking Device

401=Tamper Proof Seal

402=Logo or Text

403=Bar code (or similar identification mark)

The present invention is further directed to the embodiments discussed below.

### Other Embodiments:

Page Lock System Embodiments:

1. A page lock system for preventing uncontrolled reading of printed material, said system comprising: a first sheet of material having a first sheet major surface extending along a front surface of said first sheet, and a first sheet outer periphery surrounding said first sheet major surface; and a second sheet of material having a second sheet major surface extending along a rear surface of said second sheet, and a second sheet outer periphery surrounding said second sheet major surface; said first sheet of material being attachable to said second sheet of material along at least a portion of (i) said first sheet outer periphery and (ii) said second sheet outer periphery so as to form a sealed enclosure sized to house a piece of printed material and having an overall thickness extending from said front surface to said rear surface; wherein (1) at least one of said first sheet major surface and said second sheet major surface further comprises a slot extending therethrough along a length thereof, each slot being sized to enable (i) one or more covers or (ii) one or more covers and one or more pages of the piece of printed material to extend therethrough, or (2) at least one of said first sheet major surface and said second sheet major surface further comprises a barcode along an outer surface thereof, said barcode providing electronic data relating to the piece of printed material, or (3) both (1) and (2).
2. The page lock system of embodiment 1, wherein (i) said first sheet of material further comprises first sheet side walls extending between said first sheet major surface and said first sheet outer periphery, (ii) said second sheet of material further comprises second sheet side walls extending between said second sheet major surface and said second sheet outer periphery, or (iii) both (i) and (ii).
3. The page lock system of embodiment 1 or 2, wherein said first sheet of material further comprises first sheet side walls extending between said first sheet major surface and said first sheet outer periphery.
4. The page lock system of any one of embodiments 1 to 3, wherein said second sheet of material further comprises second sheet side walls extending between said second sheet major surface and said second sheet outer periphery.
5. The page lock system of any one of embodiments 2 to 4, wherein (i) said first sheet of material further comprises a first sheet outer edge extending between said first sheet side walls and said first sheet outer periphery, and (ii) said second sheet of material further comprises a second sheet outer edge extending between said second sheet side walls and said second sheet outer periphery.
6. The page lock system of any one of embodiments 1 to 5, wherein each of said first sheet outer periphery and said second sheet outer periphery has a four-sided configuration.
7. The page lock system of any one of embodiments 1 to 6, wherein each of said first sheet outer periphery and said second sheet outer periphery has a four-sided rectangular-shaped configuration.
8. The page lock system of any one of embodiments 1 to 7, wherein said first sheet of material and said second sheet of material are attached to one another along one side edge of said first sheet and second sheet outer peripheries.
9. The page lock system of any one of embodiments 1 to 8, wherein at least one slot is present, and each slot extends a complete length of (i) said first sheet major surface, (ii) said second sheet major surface, or (iii) both (i) and (ii).
10. The page lock system of embodiment 8, wherein at least one slot is present, and each slot (a) extends a complete length of (i) said first sheet major surface, (ii) said second sheet major surface, or (iii) both (i) and (ii), and (b) each slot is parallel to said one side edge.
11. The page lock system of any one of embodiments 1 to 10, wherein said first sheet major surface comprises a slot therethrough.
12. The page lock system of any one of embodiments 1 to 11, wherein said second sheet major surface comprises a slot therethrough.
13. The page lock system of any one of embodiments 1 to 12, wherein when (i) said first sheet of material and (ii) said second sheet of material are positioned so as to overlap one another so that said first sheet outer periphery is aligned with said second sheet outer periphery, said front surface is positioned a distance of at least 5.0 millimeters (mm) from said rear surface. It should be noted that the page lock system of the present invention may have any dimensions. Typically, the front surface is positioned a distance from the rear surface, wherein the distance is from about 5.0 mm to about 1000 mm (or any value from 5.0 mm to 1000 mm, in increments of 0.1 mm, e.g., 24.2 mm, or any range of values from 5.0 mm to 1000 mm, in increments of 0.1 mm, e.g., from about 13.5 to about 42.2 mm).
14. The page lock system of any one of embodiments 1 to 13, wherein when (i) said first sheet of material and (ii) said second sheet of material are positioned so as to overlap one another so that said first sheet outer periphery is aligned with said second sheet outer periphery, said front surface is positioned a distance of at least 25 mm from said rear surface.
15. The page lock system of any one of embodiments 1 to 14, wherein when (i) said first sheet of material and (ii) said second sheet of material are positioned so as to overlap one another so that said first sheet outer periphery is aligned with said second sheet outer periphery, said front surface is positioned a distance of from about 25 mm to about 500 mm from said rear surface.
16. The page lock system of any one of embodiments 1 to 15, wherein when (i) said first sheet of material and (ii) said second sheet of material are positioned so as to overlap one another so that said first sheet outer periphery is aligned with said second sheet outer periphery, said page lock system has an overall width dimension of from about 100 mm to about 1000 mm (or any value from 100 mm to 1000 mm, in increments of 0.1 mm, e.g., 124.2 mm, or any range of values from 100 mm to 1000 mm, in increments of 0.1 mm, e.g., from about 131.5 to about 422.2 mm), and an overall length dimension of from about 100 mm to about 1000 mm (or any value from 100 mm to 1000 mm, in increments of 0.1 mm, e.g., 214.2 mm, or any range of values from 100 mm to 1000 mm, in increments of 0.1 mm, e.g., from about 133.5 to about 142.2 mm).
17. The page lock system of any one of embodiments 1 to 16, wherein when (i) said first sheet of material, (ii) said second sheet of material, or (iii) both (i) and (ii) are transparent or translucent.
18. The page lock system of any one of embodiments 1 to 17, wherein each of (i) said first sheet of material and (ii) said second sheet of material independently comprises a polymeric sheet of material.
19. The page lock system of any one of embodiments 1 to 18, wherein each of (i) said first sheet of material and (ii) said second sheet of material independently comprises a rigid polymeric sheet of material.
20. The page lock system of any one of embodiments 1 to 19, wherein (i) said first sheet of material, (ii) said second sheet of material, or (iii) both (i) and (ii) comprises a cut line extending along an outer edge thereof.
21. The page lock system of any one of embodiments 1 to 20, wherein (i) said first sheet of material, (ii) said second sheet of material, or (iii) both (i) and (ii) further comprise the barcode (or any other type of printed material that identifies the page lock system with or without printed material positioned within the page lock system).
22. The page lock system of any one of embodiments 1 to 21, in combination with a piece of printed material, said piece of printed material comprising a book, a magazine, a product brochure, or any other object comprising multiple printed pages.
23. The page lock system of any one of embodiments 1 to 22, in combination with a piece of printed material sealed within a cavity formed by sealing said first sheet outer periphery of said first sheet of material to said second sheet outer periphery of said second sheet of material, wherein at least (i) one or more covers or (ii) one or more covers and one or more pages of said piece of printed material extend through said slot or slots so that a reader can have limited access to said (i) one or more covers or (ii) one or more covers and one or more pages of said piece of printed material, said piece of printed material comprising a book, a magazine, a product brochure, or any other object comprising multiple printed pages.

Methods of Making Page Lock System Embodiments:

24. A method of making the page lock system of any one of embodiments 1 to 23, said method comprising: forming the first sheet of material; forming the second sheet of material; wherein the first sheet of material is attachable to the second sheet of material along at least a portion of (i) the first sheet outer periphery and (ii) the second sheet outer periphery so as to form a sealed enclosure sized to house a piece of printed material and having an overall thickness extending from the front surface to the rear surface; wherein at least one of said forming steps further comprises forming a slot extending through (i) the first sheet major surface, (ii) the second sheet major surface, or (iii) both (i) and (ii), each slot being sized to enable (i) one or more covers or (ii) one or more covers and one or more pages of the piece of printed material to extend therethrough.
25. A method of making a page lock system, said method comprising: forming a first sheet of material having a first sheet major surface extending along a front surface of the first sheet, and a first sheet outer periphery surrounding the first sheet major surface; forming a second sheet of material having a second sheet major surface extending along a rear surface of the second sheet, and a second sheet outer periphery surrounding the second sheet major surface; wherein the first sheet of material is attachable to the second sheet of material along at least a portion of (i) the first sheet outer periphery and (ii) the second sheet outer periphery so as to form a sealed enclosure sized to house a piece of printed material and having an overall thickness extending from the front surface to the rear surface; and wherein said method further comprises at least one of: (1) forming a slot extending through (i) the first sheet major surface, (ii) the second sheet major surface, or (iii) both (i) and (ii), each slot being sized to enable (i) one or more covers or (ii) one or more covers and one or more pages of the piece of printed material to extend therethrough, and (2) providing a barcode along an outer surface of (i) the first sheet major surface, (ii) the second sheet major surface, or (iii) both (i) and (ii).
26. The method of embodiment 25, wherein said method comprises: forming a slot extending through (i) the first sheet major surface, (ii) the second sheet major surface, or (iii) both (i) and (ii), each slot being sized to enable (i) one or more covers or (ii) one or more covers and one or more pages of the piece of printed material to extend therethrough.
27. The method of any one of embodiments 24 to 26, wherein said method comprises: providing a barcode along an outer surface of (i) the first sheet major surface, (ii) the second sheet major surface, or (iii) both (i) and (ii).
28. The method of any one of embodiments 24 to 27, wherein said method further comprises: forming one or more features as described in embodiments 1 to 23.

Methods of Using Page Lock System Embodiments:

29. A method of using the page lock system of any one of embodiments 1 to 23, said method comprising: viewing (i) one or more covers or (ii) one or more covers and one or more pages of a piece of printed material extending through at least one slot through (i) the first sheet major surface, (ii) the second sheet major surface, or (iii) both (i) and (ii).
30. A method of using the page lock system of any one of embodiments 1 to 23, said method comprising: positioning the first sheet of material over a first cover of a piece of printed material; positioning the second sheet of material over a second cover of the piece of printed material, the second cover being opposite the first cover; and attaching the first sheet of material to the second sheet of material along at least a portion of (i) the first sheet outer periphery and (ii) the second sheet outer periphery so as to form a sealed enclosure housing the piece of printed material such that (i) one or more covers or (ii) one or more covers and one or more pages of the piece of printed material extend through a slot extending through (i) the first sheet major surface, (ii) the second sheet major surface, or (iii) both (i) and (ii).
31. A method of using a page lock system, said method comprising: positioning a first sheet of material having a first sheet major surface extending along a front surface of the first sheet, and a first sheet outer periphery surrounding the first sheet major surface over a first cover of a piece of printed material; positioning a second sheet of material having a second sheet major surface extending along a rear surface of the second sheet, and a second sheet outer periphery surrounding the second sheet major surface over a second cover of the piece of printed material, the second cover being opposite the first cover; and attaching the first sheet of material to the second sheet of material along at least a portion of (i) the first sheet outer periphery and (ii) the second sheet outer periphery so as to form a sealed enclosure housing the piece of printed material such that: (1) (i) one or more covers or (ii) one or more covers and one or more pages of the piece of printed material extend through a slot extending through (i) the first sheet major surface, (ii) the second sheet major surface, or (iii) both (i) and (ii), (2) a barcode along an outer surface of (i) the first sheet major surface, (ii) the second sheet major surface, or (iii) both (i) and (ii) is viewable by a user, or (3) both (1) and (2).
32. The method of embodiment 31, said method comprising: viewing (i) one or more covers or (ii) one or more covers and one or more pages of the piece of printed material that extend through at least one slot through (i) the first sheet major surface, (ii) the second sheet major surface, or (iii) both (i) and (ii).
33. The method of embodiment 31, said method comprising: viewing (i) one or more covers or (ii) one or more outermost pages of the piece of printed material through (i) the first sheet major surface, (ii) the second sheet major surface, or (iii) both (i) and (ii).
34. The method of any one of embodiments 30 to 33, said method further comprising: obtaining information about the piece of printed material via a barcode positioned along an outer surface of (i) the first sheet major surface, (ii) the second sheet major surface, or (iii) both (i) and (ii).

It should be understood that although the above-described page lock systems, and methods of making and using the same are described as “comprising” one or more components or steps, the above-described page lock systems, and methods of making and using the same may “comprise,” “consists of,” or “consist essentially of” any of the above-described components or steps of the page lock systems, and methods of making and using the same. Consequently, where the present invention, or a portion thereof, has been described with an open-ended term such as “comprising,” it should be readily understood that (unless otherwise stated) the description of the present invention, or the portion thereof, should also be interpreted to describe the present invention, or a portion thereof, using the terms “consisting essentially of” or “consisting of” or variations thereof as discussed below.

As used herein, the terms “comprises,” “comprising,” “includes,” “including,” “has,” “having,” “contains”, “containing,” “characterized by” or any other variation thereof, are intended to encompass a non-exclusive inclusion, subject to any limitation explicitly indicated otherwise, of the recited components. For example, a page lock system, and/or method of using a page lock system that “comprises” a list of elements (e.g., components or steps) is not necessarily limited to only those elements (or components or steps), but may include other elements (or components or steps) not expressly listed or inherent to the page lock system, and/or method.

As used herein, the transitional phrases “consists of” and “consisting of” exclude any element, step, or component not specified. For example, “consists of” or “consisting of” used in a claim would limit the claim to the components, materials or steps specifically recited in the claim except for impurities ordinarily associated therewith (i.e., impurities within a given component). When the phrase “consists of” or “consisting of” appears in a clause of the body of a claim, rather than immediately following the preamble, the phrase “consists of” or “consisting of” limits only the elements (or components or steps) set forth in that clause; other elements (or components) are not excluded from the claim as a whole.

As used herein, the transitional phrases “consists essentially of” and “consisting essentially of” are used to define a page lock system, and/or method that includes materials, steps, features, components, or elements, in addition to those literally disclosed, provided that these additional materials, steps, features, components, or elements do not materially affect the basic and novel characteristic(s) of the claimed invention. The term “consisting essentially of” occupies a middle ground between “comprising” and “consisting of”.

Further, it should be understood that the herein-described page lock systems, and/or methods of making and using page lock systems may comprise, consist essentially of, or consist of any of the herein-described components and features, as shown in the figures with or without any feature(s) not shown in the figures. In other words, in some embodiments, the page lock systems, and/or methods of making and using page lock systems of the present invention do not have any additional features other than those shown in the figures, and such additional features, not shown in the figures, are specifically excluded from the page lock systems, and/or methods of making and using page lock systems. In other embodiments, the page lock systems, and/or methods of making and using page lock systems of the present invention do have one or more additional features that are not shown in the figures.

The present invention is further illustrated by the following examples, which are not to be construed in any way as imposing limitations upon the scope thereof. On the contrary, it is to be clearly understood that resort may be had to various other embodiments, modifications, and equivalents thereof which, after reading the description herein, may suggest themselves to those skilled in the art without departing from the spirit of the present invention and/or the scope of the appended claims.

### Example 1

Page lock systems, similar to exemplary page lock system 100 shown in FIGS. 1-11, were prepared.

While the specification has been described in detail with respect to specific embodiments thereof, it will be appreciated that those skilled in the art, upon attaining an understanding of the foregoing, may readily conceive of alterations to, variations of, and equivalents to these embodiments. Accordingly, the scope of the present invention should be assessed as that of the appended claims and any equivalents thereto.

1. A page lock system for preventing uncontrolled reading of printed material, said system comprising:
a first sheet of material having a first sheet major surface extending along a front surface of said first sheet, and a first sheet outer periphery surrounding said first sheet major surface; and
a second sheet of material having a second sheet major surface extending along a rear surface of said second sheet, and a second sheet outer periphery surrounding said second sheet major surface;
said first sheet of material being attachable to said second sheet of material along at least a portion of (i) said first sheet outer periphery and (ii) said second sheet outer periphery so as to form a sealed enclosure sized to house a piece of printed material and having an overall thickness extending from said front surface to said rear surface;
wherein (1) at least one of said first sheet major surface and said second sheet major surface further comprises a slot extending therethrough along a length thereof, each slot being sized to enable (i) one or more covers or (ii) one or more covers and one or more pages of the piece of printed material to extend therethrough, or (2) at least one of said first sheet major surface and said second sheet major surface further comprises a barcode along an outer surface thereof, said barcode providing electronic data relating to the piece of printed material, or (3) both (1) and (2).

2. The page lock system of claim 1, wherein (i) said first sheet of material further comprises first sheet side walls extending between said first sheet major surface and said first sheet outer periphery, (ii) said second sheet of material further comprises second sheet side walls extending between said second sheet major surface and said second sheet outer periphery, or (iii) both (i) and (ii).

3. The page lock system of claim 1, wherein said first sheet of material further comprises first sheet side walls extending between said first sheet major surface and said first sheet outer periphery.

4. The page lock system of claim 1, wherein said second sheet of material further comprises second sheet side walls extending between said second sheet major surface and said second sheet outer periphery.

5. The page lock system of claim 2, wherein (i) said first sheet of material further comprises a first sheet outer edge extending between said first sheet side walls and said first sheet outer periphery, and (ii) said second sheet of material further comprises a second sheet outer edge extending between said second sheet side walls and said second sheet outer periphery.

6. The page lock system of claim 1, wherein each of said first sheet outer periphery and said second sheet outer periphery has a four-sided configuration.

7. The page lock system of claim 1, wherein each of said first sheet outer periphery and said second sheet outer periphery has a four-sided rectangular-shaped configuration.

8. The page lock system of claim 1, wherein said first sheet of material and said second sheet of material are attached to one another along one side edge of said first sheet and second sheet outer peripheries.

9. The page lock system of claim 1, wherein at least one slot is present, and each slot extends a complete length of (i) said first sheet major surface, (ii) said second sheet major surface, or (iii) both (i) and (ii).

10. The page lock system of claim 8, wherein at least one slot is present, and each slot (a) extends a complete length of (i) said first sheet major surface, (ii) said second sheet major surface, or (iii) both (i) and (ii), and (b) is parallel to said one side edge.

11. The page lock system of claim 1, wherein each of said first sheet major surface and said second sheet major surface comprises a slot therethrough.

12. The page lock system of claim 5, wherein each of said first sheet major surface and said second sheet major surface comprises a slot therethrough.

13. The page lock system of claim 1, wherein at least one of said first sheet major surface and said second sheet major surface comprises the barcode along an outer surface thereof.

14. The page lock system of claim 10, wherein at least one of said first sheet major surface and said second sheet major surface comprises the barcode along an outer surface thereof.

15. The page lock system of claim 1, wherein when (i) said first sheet of material and (ii) said second sheet of material are positioned so as to overlap one another so that said first sheet outer periphery is aligned with said second sheet outer periphery, said front surface is positioned a distance of from about 5.0 mm to about 100 mm from said rear surface, said page lock system has an overall width dimension of from about 100 mm to about 1000 mm, and said page lock system has an overall length dimension of from about 100 mm to about 1000 mm.

16. The page lock system of claim 1, wherein when (i) said first sheet of material, (ii) said second sheet of material, or (iii) both (i) and (ii) are transparent or translucent.

17. The page lock system of claim 1, wherein each of (i) said first sheet of material and (ii) said second sheet of material independently comprises a polymeric sheet of material.

18. The page lock system of claim 1, wherein each of (i) said first sheet of material and (ii) said second sheet of material independently comprises a rigid polymeric sheet of material.

19. The page lock system of claim 1, wherein (i) said first sheet of material, (ii) said second sheet of material, or (iii) both (i) and (ii) comprises a cut line extending along an outer edge thereof.

20. The page lock system of claim 1, in combination with a piece of printed material sealed within a cavity formed by sealing said first sheet outer periphery of said first sheet of material to said second sheet outer periphery of said second sheet of material, wherein at least (i) one or more covers or (ii) one or more covers and one or more pages of said piece of printed material extend through said slot or slots so that a reader can have limited access to said (i) one or more covers or (ii) one or more covers and one or more pages of said piece of printed material, said piece of printed material comprising a book, a magazine, a product brochure, or any other object comprising multiple printed pages.
